(19) United States
(12) Patent Application Publication
(10) Pub. No.: US 2024/0300359 A1
(43) Pub. Date: Sep. 12, 2024

(54) ENERGY MANAGEMENT METHOD AND COMPUTER SYSTEM

(71) Applicant: TOYOTA JIDOSHA KABUSHIKI KAISHA, Toyota-shi (JP)

(72) Inventor: Kazuhisa MATSUDA, Ebina-shi (JP)

(73) Assignee: TOYOTA JIDOSHA KABUSHIKI KAISHA, Toyota-shi (JP)

(21) Appl. No.: 18/526,153

(22) Filed: Dec. 1, 2023

(30) Foreign Application Priority Data
Mar. 7, 2023 (JP) 2023-034642

(51) Int. Cl. B60L 53/62

(52) U.S. Cl. CPC B60L 53/62

(57) ABSTRACT

The energy management method includes scheduling charging of the electrified vehicle for energy management to be performed at a predetermined charging center on a predetermined execution date, when pre-charging operation of the electrified vehicle is detected at a location other than the charging site on the execution date, calculating a recommended value of a charging amount at the location for the electrified vehicle, requesting permission from a user of the electrified vehicle to set an upper limit value of a charging amount at a location other than the charging site to the recommended value, and when the permission is received from the user of the electrified vehicle, setting the upper limit value of the charging amount at a location other than the charging site to the recommended value.

### CROSS-REFERENCE TO RELATED APPLICATION

This application claims priority to Japanese Patent Application No. 2023-034642 filed on Mar. 7, 2023, incorporated herein by reference in its entirety.

### BACKGROUND

### 1. Technical Field

The present disclosure relates to an energy management method and a computer system.

### 2. Description of Related Art

Japanese Unexamined Patent Application Publication No. 2016-171634 (JP 2016-171634 A) discloses a method of performing energy management using an electrified vehicle that includes a power storage device.

### SUMMARY

In the energy management method disclosed in JP 2016-171634 A, actions of a user are predicted, and a charging schedule for the power storage device installed in the electrified vehicle (power supply schedule for the electrified vehicle) is managed based on the results of the prediction. However, the user does not necessarily act as predicted. Also, when the electrified vehicle is controlled so that the user can only act as predicted, there is a possibility that the user will be excessively inconvenienced.

The present disclosure has been made to address the above issue, and it is an object thereof to achieve both executability of energy management and user convenience.

One aspect of the present disclosure provides an energy management method including: scheduling charging of an electrified vehicle for energy management to be executed at a predetermined charging site on a predetermined execution date;
when pre-charging operation of the electrified vehicle is detected at a location other than the charging site on the execution date, calculating a recommended value of a charging amount at the location for the electrified vehicle;
requesting permission from a user of the electrified vehicle to set an upper limit value of a charging amount at a location other than the charging site to the recommended value of the charging amount; and
when the permission is received from the user of the electrified vehicle, setting the upper limit value of the charging amount at a location other than the charging site to the recommended value of the charging amount.

According to the above method, it is possible to achieve both executability of energy management and user convenience.

Another aspect of the present disclosure provides a computer system including: one or more processors; and one or more storage devices that store a program that causes the one or more processors to execute the energy management method described above.

According to the above computer system, the energy management method described above is suitably executed. The above computer system may include a plurality of processors installed in separate computers, and a plurality of storage devices installed in separate computers.

According to the present disclosure, it is possible to achieve both executability of energy management and user convenience.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an energy management system according to an embodiment of the present disclosure;

FIG. 2 is a diagram showing the charging state of the electrified vehicle shown in FIG. 1;

FIG. 3 is a diagram for explaining prediction of vehicle behavior by the server shown in FIG. 1 and electricity trading based on the prediction result;

FIG. 4 is a diagram for explaining the outline of tertiary adjustment force-2;

FIG. 5 is a flowchart illustrating an energy management method according to an embodiment of the present disclosure; and

FIG. 6 is a diagram showing a modification of the energy management method shown in FIG. 5.

### DETAILED DESCRIPTION OF EMBODIMENTS

An embodiment of the present disclosure will be described in detail with reference to the drawings. In the drawings, the same or corresponding parts are denoted by the same reference signs and the description thereof will not be repeated.

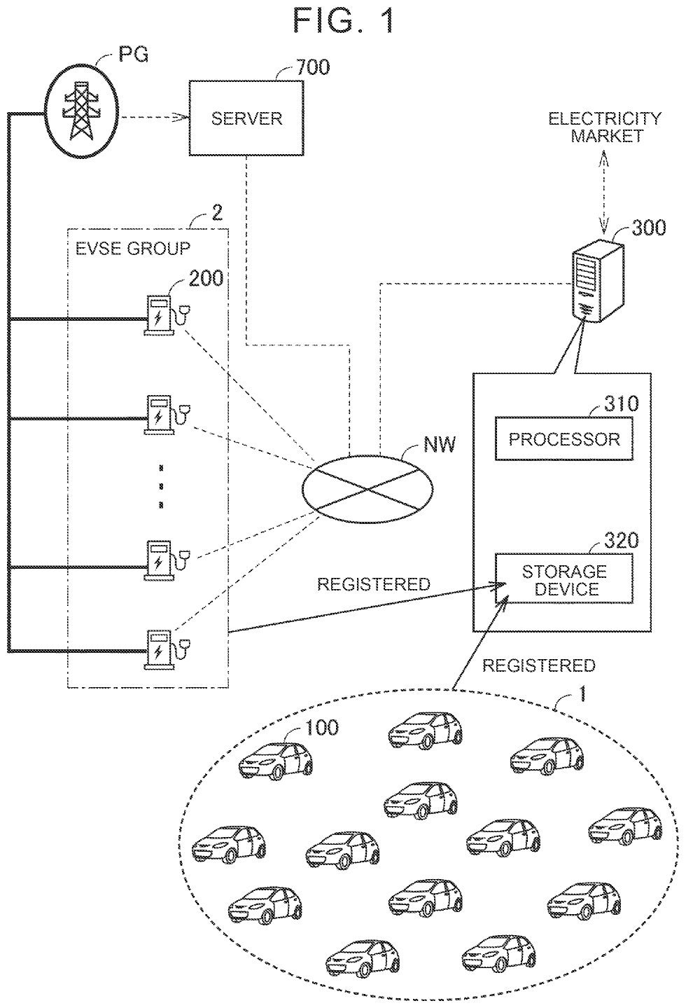

FIG. 1 is a diagram showing a schematic configuration of an energy management system according to an embodiment of the present disclosure. Referring to FIG. 1, the energy management system according to this embodiment executes energy management of a power grid PG. This energy management system includes a vehicle group 1, an EVSE group 2, and servers 300,700. EVSE means Electric Vehicle Supply Equipment.

The power grid PG is a power network constructed by power transmission and distribution facilities. A plurality of power plants are connected to the power grid PG. Vehicle group 1 includes a plurality of electrified vehicles (xEV) that can operate as a regulating force for power grid PG. EVSE group 2 includes a plurality of EVSEs supplied with power from power grid PG.

Server 300 includes processor 310 and storage device 320. Server 300 may be a computer belonging to an aggregator. The server 700 belongs to, for example, the TSO (system operator) of the power grid PG. Server 300 and server 700 are configured to be able to communicate with each other via communication network NW. The communication network NW is, for example, a wide area network constructed by the Internet and wireless base stations.

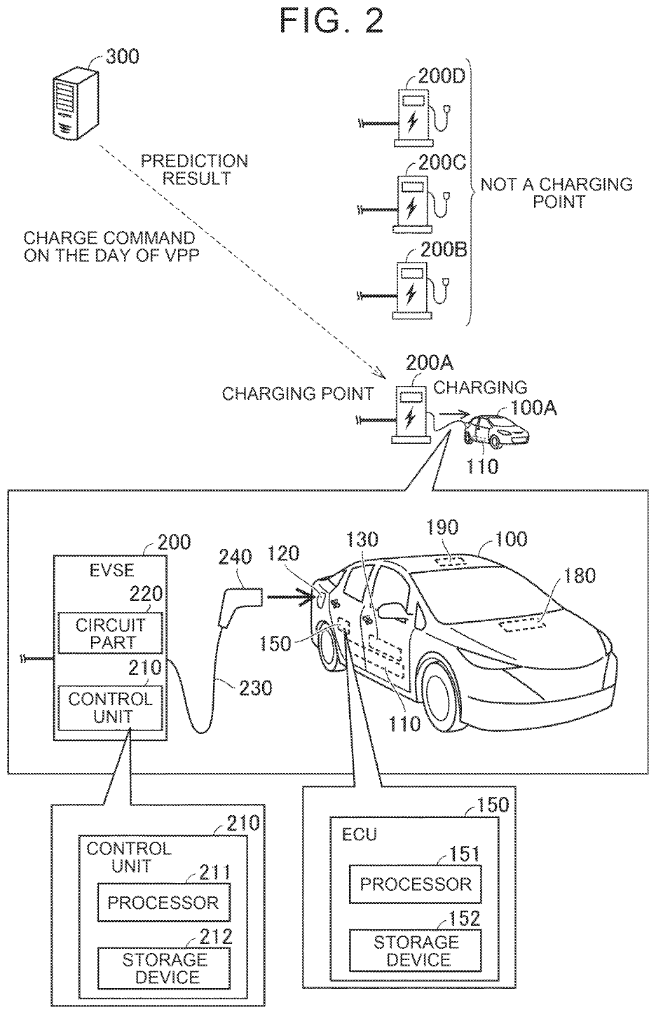

Each vehicle included in vehicle group 1 and each EVSE included in EVSE group 2 are both configured to communicate with server 300 via communication network NW. Each of these vehicles and each EVSE is registered with server 300. The storage device 320 stores information (for example, specifications, charging stations, user information, incentive information, etc.) about each registered vehicle, distinguishing them by vehicle identification information (vehicle ID). In addition, the storage device 320 stores information (e.g., specifications, location information, etc.) about each registered EVSE, distinguishing them by EVSE identification information (EVSE-ID). Hereinafter, the configuration will be explained using FIG. 2 in which each vehicle included in vehicle group 1 (hereinafter referred to as “vehicle 100” if not distinguished) and each EVSE included in EVSE group 2 (hereinafter referred to as “EVSE 200” if not distinguished). FIG. 2 is a diagram showing the state of vehicle 100 during charging.

Referring to FIG. 2, vehicle 100 includes a battery 110, an inlet 120, a charging circuit 130, an electronic control unit (hereinafter referred to as “Electronic Control Unit (ECU)”) 150, and a Human Machine Interface (HMI) 180 and a communication device 190. Vehicle 100 may further include an air conditioner (not shown). ECU 150 includes a processor 151 and a storage device 152. Vehicle 100 is an electrified vehicle (xEV) configured to run using electric power stored in battery 110. Vehicle 100 is, for example, a battery electric vehicle (BEV) without an internal combustion engine. As the battery 110, a known vehicle power storage device (a liquid secondary battery, an all-solid secondary battery, an assembled battery, etc.) can be employed.

Inlet 120 includes a charging port and a charging lid. The charging lid is configured to be openable and closable by the user, covering the charging port when closed and exposing the charging port when opened. When charging the battery 110, the connector 240 of the charging cable 230 is connected to the charging port while the charging lid is open. The charging circuit 130 is a circuit that charges the battery 110 using electric power supplied to the charging port from outside the vehicle. Charging circuit 130 is controlled by ECU 150. However, charging circuit 130 may charge battery 110 in response to a command from outside the vehicle. The charging of the battery 110 mounted on the vehicle 100 is hereinafter sometimes referred to as the charging of the vehicle 100.

HMI 180 includes a navigation system. Information set in the navigation system is hereinafter referred to as “navigation information”. Examples of navigation information include travel routes and destinations. HMI 180 may include a touch panel display and/or a smart speaker that accepts voice input.

Detection values from various sensors (not shown) mounted on vehicle 100 are input to ECU 150. Vehicle 100 is equipped with a position sensor, a vehicle speed sensor, an accelerator sensor, an outside air temperature sensor, a battery sensor, a charging lid opening/closing sensor, a charging cable connection sensor, and the like. The position sensor may detect the position of the vehicle 100 using a positioning system such as a Global

Positioning System (GPS). Battery sensors include various sensors that detect the state of battery 110 (e.g., voltage, current, temperature, and SOC). The State of Charge (SOC) indicates, for example, the ratio of the current amount of stored power to the amount of stored power in a fully charged state.

ECU 150 communicates with server 300 through communication device 190. The communication device 190 may include a wireless communication device (e.g., a Data Communication Module (DCM)) that can access the communication network NW. Vehicle 100 sequentially transmits detection results from onboard sensors (for example, a position sensor and an SOC sensor) to server 300. Moreover, the latest navigation information is transmitted from the vehicle 100 to the server 300 every time the navigation information is updated.

The main body of EVSE 200 incorporates control unit 210 and circuit unit 220. EVSE 200 further comprises a charging cable 230 extending outwardly from the body of EVSE 200. Control unit 210 includes processor 211 and storage device 212 and controls circuit unit 220. Circuit unit 220 includes a circuit (for example, a power conversion circuit) for feeding power supplied from power grid PG to vehicle 100. A connector 240 (plug) that can be attached to and detached from the charging port of inlet 120 is provided at the tip of charging cable 230. By connecting the connector 240 of the charging cable 230 connected to the main body of the EVSE 200 to the inlet 120 of the parked vehicle 100, the vehicle 100 becomes electrically connected to the EVSE 200 (plug-in state). EVSE 200 and power grid PG are electrically connected. Therefore, vehicle 100 in the plugged-in state is electrically connected to power grid PG.

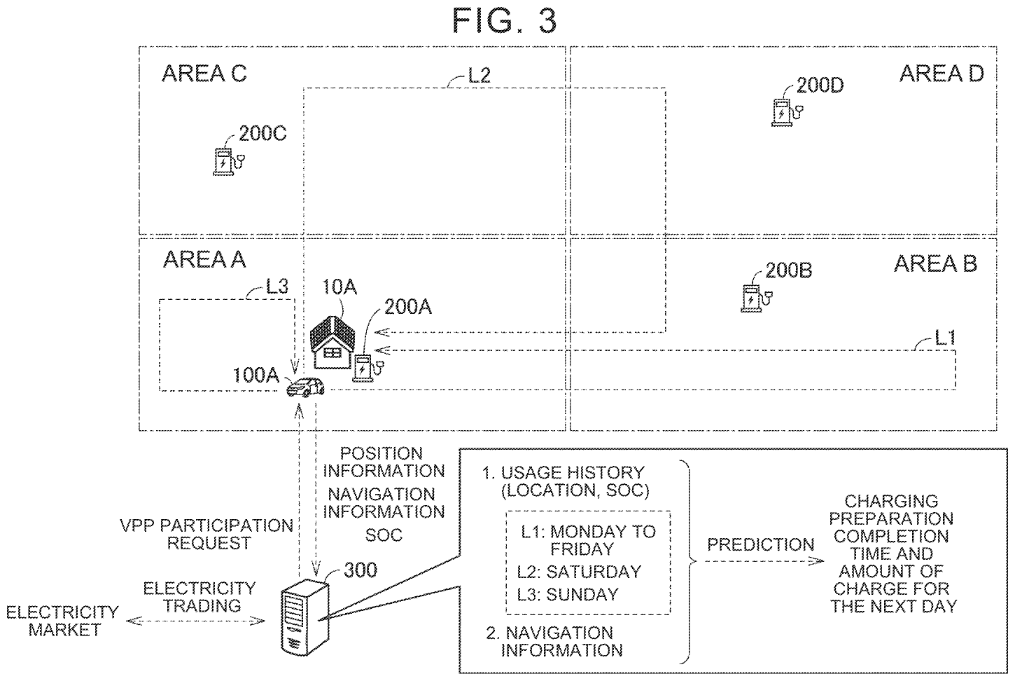

A prediction program that predicts future behavior (usage mode) of vehicle 100 from past usage data of vehicle 100 is installed in server 300. The server 300 performs power trading based on the prediction results. FIG. 3 is a diagram for explaining prediction of vehicle behavior by server 300 and electricity trading based on the prediction result. The EVSEs 200 existing in areas A, B, C, and D shown in FIG. 3 are hereinafter referred to as EVSEs 200A, 200B, 200C, and 200D, respectively. Also, the vehicle 100 belonging to the user living in the house 10A in the area A is referred to as “vehicle 100A”. The EVSE 200A corresponds to power supply equipment installed in the house 10A (user's home). The position of house 10A (EVSE 200A) is registered in server 300 as a charging base for vehicle 100A. In this embodiment, the charging point of each vehicle included in vehicle group 1 (e.g., the user's home and/or workplace) is registered with server 300.

In this embodiment, the user uses vehicle 100A for commuting. For example, the vehicle 100A leaves on a weekday morning and returns home in the evening of the same day. On weekdays, it is predicted that the vehicle 100A that leaves for work in the morning (for example, around 8 a.m.) returns home in the evening (for example, around 5 p.m.) and enters the plug-in state. However, the user may behave irregularly.

Server 300 predicts the next day's charging preparation completion time and charging amount for the charging base of vehicle 100. The predicted charging preparation completion time is the time when vehicle 100 becomes ready for charging at the charging station. In this embodiment, the charging preparation completion time corresponds to the time when vehicle 100 leaves the charging base, returns to the charging base after traveling, is connected to EVSE 200, and enters the plug-in state. The predicted charge amount is the amount of electric power (kWh) stored in vehicle 100 by charging using EVSE 200 after completion of preparation for charging at the charging station, and equivalent to the value obtained by subtracting the amount of charge at the start of charging from the amount of charge at the end of charging.

Server 300 may acquire information for the above prediction from vehicle 100. Specifically, the server 300 sequentially acquires various types of information (e.g., position information, SOC, and navigation information) from the vehicle 100, and uses data of the vehicle 100 (e.g., data indicating the position and state of the vehicle 100 during travel) is recorded in the storage device 320. The usage data may include, for example, the position and SOC of vehicle 100 for each time.

Server 300, for example, uses the usage data (usage history) stored in storage device 320 to predict the next day's return time of vehicle 100A and the state of charge (SOC) of vehicle 100A at the return time. Server 300 may predict the amount of charge of vehicle 100A for the next day based on the amount of power stored in vehicle 100A at the time of returning home the next day. Based on the usage history of vehicle 100A, server 300 can predict the next day's travel route and travel schedule, as well as the power consumption due to the next day's travel. The server 300 may predict the return home time from the predicted travel schedule. The server 300 may predict the power storage amount (remaining battery level) at the time of returning home from the predicted power consumption. Server 300 may manage the usage history of vehicle 100A for each day of the week, and predict the travel route and travel schedule based on the cumulative probability for each day of the week. In the example shown in FIG. 3, the server 300 manages usage histories separately for weekdays (Monday to Friday), Saturdays, and Sundays. Then, server 300 separately predicts weekday travel route L1, Saturday travel route L2, and Sunday travel route L3 based on the corresponding usage history. However, the prediction mode shown in FIG. 3 is only an example and can be changed as appropriate.

When server 300 receives the next day's navigation information from vehicle 100A, server 300 also considers the next day's navigation information and predicts the next day's return time and charge amount. When the navigation information of vehicle 100A is updated, there is a possibility that the user is planning irregular travel. Therefore, server 300 may rely more on the navigation information than on the usage history, and predict the return time and amount of charge of vehicle 100A on the next day based on the next day's navigation information.

The server 300 can predict the charging preparation completion time from the time of returning home. Server 300 may estimate that vehicle 100A will be connected to EVSE 200A and will be in a plug-in state after a predetermined time (for example, 1 minute to 10 minutes) has passed since the time of returning home. When the vehicle 100A returns home, the HMI 180 may prompt the user to prepare for charging (for example, put the vehicle in a plug-in state).

In this embodiment, when vehicle 100 is connected to EVSE 200 at the charging base and enters a plug-in state, vehicle 100 receives charging control from EVSE 200 at the charging base (specifically, control unit 210 shown in FIG. 2) will be allowed. In this state, charging circuit 130 (vehicle charger) shown in FIG. 2 charges battery 110 according to instructions from EVSE 200. For example, at home 10A, EVSE 200A receives prediction results for vehicle 100A from server 300. On days when energy management is not performed, EVSE 200A charges vehicle 100A based on the results predicted by server 300 (that is, charging preparation completion time and charge amount predicted on the previous day). For example, if vehicle 100A becomes chargeable at home 10A before the predicted charge preparation completion time, charging of vehicle 100A may be started at the predicted charge preparation completion time. If vehicle 100A becomes chargeable at home 10A after the predicted charging preparation completion time, charging of vehicle 100A may be started immediately (when charging becomes possible). Then, when the charging amount (kWh) of vehicle 100A reaches the predicted charging amount, charging of vehicle 100A may be terminated. However, the user of vehicle 100A operates the charging operation unit of vehicle 100A or EVSE 200A to cause EVSE 200A to operate and charge battery 110 regardless of instructions from EVSE 200A. You can also In this case, the ECU 150 controls the charging circuit 130 according to instructions from the user.

The server 300 makes the predictions described above for each vehicle included in the vehicle group 1, and automatically conducts transactions (e.g., bidding and contracting) in the electric power market based on the prediction results. Then, the server 300 makes settlements for power transactions and manages books (transaction records). In the following, tertiary adjustment force-2 will be explained as an example of regulating power that is auctioned off in the electricity market.

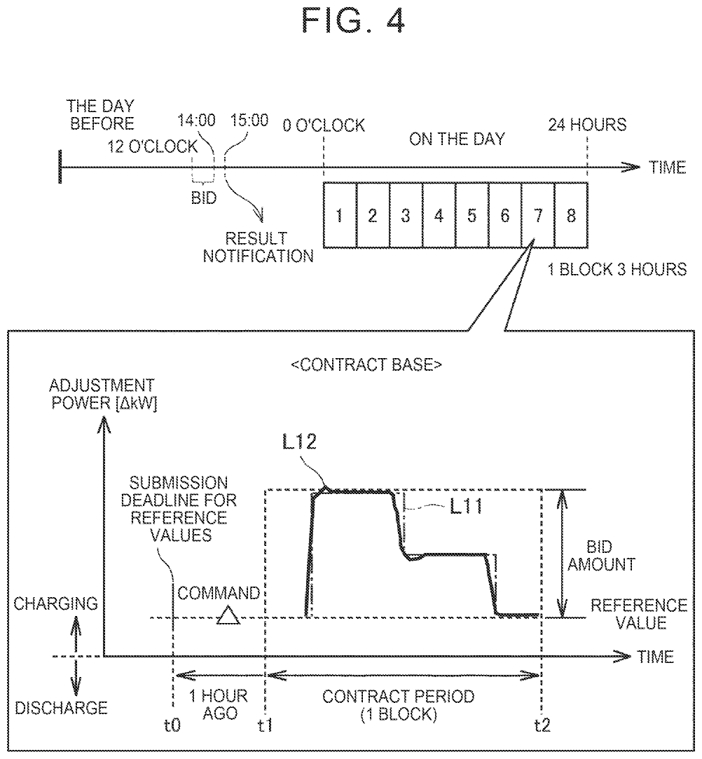

FIG. 4 is a diagram for explaining the outline of tertiary adjustment force-2. Referring to FIG. 4, tertiary adjustment force-2 is adjustment power for the Feed-in Tariff (FIT) special system, and is traded in the supply and demand adjustment market. In the supply and demand adjustment market, electricity is traded as a product. Each product is bought and sold by, for example, a bidding method. In the supply and demand adjustment market, transactions with a tertiary adjustment force-2 are conducted for each of eight blocks divided into three-hour blocks per day.

The server 300 makes a bid in the supply and demand adjustment market during the period from 12:00 to 14:00 on the day before the target block. Specifically, the server 300 transmits, to the market system, a product (for example, tertiary adjustment force-2), a block (any one of the eight blocks), an adjustment site within the target area, and bid information including the bid amount (Δkw) (i.e., bid information indicating conditions). The number of coordination bases may be one or more. After that, the result is notified to the server 300 at 15:00 on the bid date. If the bid item is awarded, the contract is concluded. The ΔkW contracted amount corresponds to the successful bid amount. Those who make a successful bid for tertiary adjustment force-2 in the supply and demand adjustment market have an obligation (contract obligation) to adjust electricity within the range of the amount of successful bids (successful bid range) set for the standard value (kW).

In this embodiment, server 300 bids on tertiary adjustment force-2. When the server 300 wins a bid on a product, the server 300 registers the reference value in the market system by the submission deadline time t0 (for example, one hour before the start time of the target block for which the bid was made). In the example shown in FIG. 4, the reference value on the charging side is registered. The charging base designated by the bidding information is also registered in the market system as a coordination base. The server 300 sequentially receives from the server 700 the target value L11 arbitrarily requested by the server 700 within the successful bid range for the target block for which the bid was made (for example, from contract period t1 to t2). The server 300 controls charging at the charging base so that the actual charging power (actual value L12) at the charging base follows the target charging power (target value L11) from the server 700 during the contract period t1 to t2. When a plurality of charging stations are specified by bidding information, server 300 controls charging at each charging station so that the total value of charging power at these charging stations approaches the target charging power. The difference between the reference value (kW) and the actual value L12 (kW) corresponds to the control power (ΔkW) of the power grid PG provided by the charging base. Penalty charges are imposed on the winning bidder if power adjustments that meet product requirements are not implemented.

As mentioned above, for tertiary adjustment force-2, bidding will be held the day before the energy management implementation date. In this embodiment, on the premise that vehicle 100 will not be charged at a charging station other than the charging station (for example, the user's home) on the day before the execution date, server 300 will charge vehicle 100 at the charging station on the execution day. It predicts the charge preparation completion time and the amount of charge, and conducts power trading according to the prediction results. Server 300 determines the bid amount to allocate to a charging station based on the predicted charging amount for that charging station.

The server 300 is configured to bundle multiple distributed energy resources (hereinafter referred to as “DER”) to realize a VPP (virtual power plant). VPP is a mechanism that functions as if it were a single power plant by remotely and integrally controlling multiple DERs. For example, vehicle 100 electrically connected to EVSE 200 may serve as a DER for VPP. The server 300 schedules charging for energy management to be executed at a predetermined charging base on a predetermined date based on the predicted charging preparation completion time and charging amount for each vehicle included in the vehicle group 1. Specifically, the server 300 selects a plurality of vehicles from the vehicle group 1 having a charging base within the target area for which energy management is requested, based on the charging preparation completion time and charging amount predicted for each vehicle, and perform energy management using multiple selected vehicles.

In power trading, the server 300 determines charging points for a plurality of vehicles and bidding amounts for the charging points based on the predicted total charging amount of each vehicle at the charging points. In the following, energy management for power grid PG is also referred to as “VPP”.

When the product for which the bid for energy management in the time zone (VPP time zone) corresponding to the target block on the VPP execution date is won, the server 300 sends the user of each vehicle corresponding to each charging station specified at the time of bidding, to request charging to be performed at the registered charging station during the VPP time zone on the VPP execution date. This request is made the day before the VPP execution date. Each vehicle that receives the request sets the VPP execution date and VPP time zone in the ECU 150. During the VPP time zone on the VPP execution date, server 300 transmits a charging command to EVSE 200 of each registered charging base based on the charging power requested by server 700 (see FIG. 2). EVSE 200 at each charging station receives a charging command from server 300 in real time and performs charging control (remote control) of vehicle 100 according to the charging command. Server 300 may give incentives (for example, points that can be exchanged for money or points that can be used to pay for electricity bills) to the user of vehicle 100 who has performed charging in response to a request.

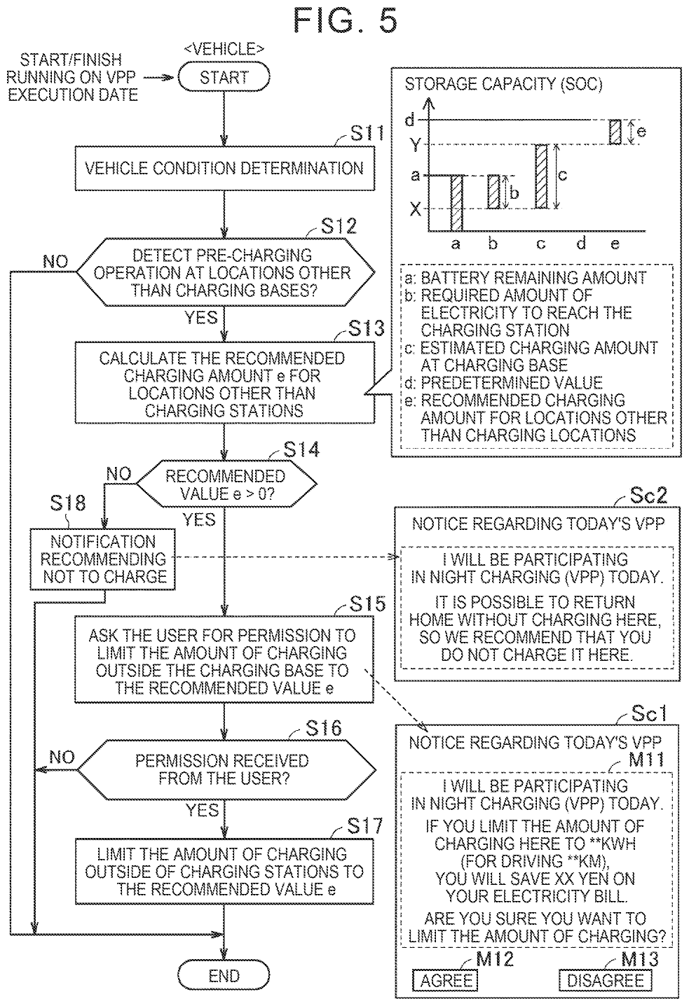

In power trading, charging at locations other than pre-designated charging bases is not certified as contracted charging (energy management). Therefore, if the vehicle 100 is charged at a place other than the charging station on that date (VPP execution date), there is a possibility that the charging amount will be insufficient for the contracted amount (amount of successful bids). Therefore, in this embodiment, vehicle 100 requested to be charged for energy management executes a series of processes shown in FIG. 5 described below, so that both the executability of the energy management and the convenience for the user is achieved.

FIG. 5 is a flowchart showing an energy management method according to this embodiment. “S” in the flowchart means a step. The process (processing flow) shown in this flowchart is executed by ECU 150, for example, when vehicle 100 starts or ends traveling on a set VPP execution date. ECU 150 may detect the start/end of running of vehicle 100 based on the on/off operation of the starting switch of vehicle 100, respectively. Generally, the activation switch is referred to as a “power switch” or “ignition switch.” In the following, an example will be described in which a night time period (for example, from 6 pm to 9 pm) is set as the VPP time zone for the vehicle 100A shown in FIG. 3. Each process shown in FIG. 5 is executed by ECU 150 of vehicle 100A.

Referring to FIG. 5, in S11, ECU 150 makes a first determination and a second determination regarding the state of vehicle 100A. The first determination is whether or not the preliminary charging operation of the vehicle 100A has been performed. The second determination is whether the vehicle 100A is scheduled to be charged at a location other than the charging base (house 10A).

In the first determination at the start of travel, the fact that the destination of the vehicle 100A is set to a place where charging is possible (first operation) corresponds to the pre-charging operation. When the vehicle 100A starts traveling, the ECU 150 determines that “preparatory charging operation is present” if the first operation is detected, and determines that “preparatory charging operation is not present” if the first operation is not detected. For example, when the vehicle 100A starts traveling, if a supermarket in which an EVSE that can be used by the vehicle 100A is installed is set as a destination in the navigation system, a pre-charging operation (first operation) is detected.

In the first determination at the end of the run, the fact that the vehicle 100A has stopped at a place where charging is possible (second operation) and the charging lid of the vehicle 100A has opened (third operation) corresponds to the pre-charging operation. When the vehicle 100A finishes traveling, the ECU 150 determines that “preparatory charging operation is present” if either the second operation or the third operation is detected, and if neither the second operation nor the third operation is detected, it is determined that there is no pre-charging operation. A place where charging is possible is, for example, a parking lot where an EVSE (power supply equipment) that can be used by the vehicle 100A is installed. When the vehicle 100A stops in the parking lot of the house 10A where the EVSE 200A is installed, a pre-charging operation (second operation) is detected. Furthermore, when the user opens the charging lid of the vehicle 100A at the end of driving the vehicle 100A, the pre-charging operation (third operation) is also detected.

According to the first to third operations described above, it becomes easier to accurately detect the preliminary charging operation of the electrified vehicle. However, the charging preparatory operation is not limited to the above first to third operations as long as the vehicle is ready for charging. Only one of the second operation and the third operation may be employed as the pre-charging operation at the end of driving.

When the pre-charging operation is detected, the ECU 150 makes a second determination. In the second judgment at the start of travel, if the destination of vehicle 100A falls somewhere other than a charging base, it is determined that there is a “charging plan at a place other than a charging base”, and the destination of vehicle 100A falls under a charging base. If so, it will be determined that there are no plans to charge anywhere other than the charging base. In the second determination at the end of the run, if the current location of vehicle 100A falls somewhere other than the charging base, it is determined that “charging is scheduled at a location other than the charging base”, and the current location of vehicle 100A falls under the charging base. If so, it will be determined that there are no plans to charge anywhere other than the charging base.

In subsequent S12, the ECU 150 determines whether a pre-charging operation is detected for a location other than the charging base. If it is determined in the first determination that there is no pre-charging operation, the determination in S12 is NO. Also, if it is determined in the second determination that there is no plan to charge at a location other than the charging base, the determination in S12 is NO. If the determination in S12 is NO, the process flow of FIG. 5 ends. For example, at the end of the run of the vehicle 100A, the ECU 150 determines the presence or absence of the pre-charging operation (second operation, third operation) during the determination period from when the start switch of the vehicle 100A is turned off until a predetermined time has elapsed. However, if the determination period elapses without the pre-charging operation being detected (first determination), the control system of the vehicle 100A may enter a non-operating state (for example, a stopped state or a sleep state). On the other hand, if the determination in S12 is NO when the vehicle 100A starts traveling, the ECU 150 may start control to prepare the vehicle 100A for traveling after the processing flow in FIG. 5 is completed.

On the other hand, if it is determined in the first determination that “preparatory charging operation is in progress” and in the second determination that “charging is scheduled at a location other than the charging base”, YES is determined in S12, and the process is performed. The process proceeds to S13. In S13, the ECU 150 calculates, for the vehicle 100A, a recommended value e of the charging amount at a location (current position or destination) other than the charging base where the preliminary charging operation was detected. Hereinafter, the location other than the charging base where the preliminary charging operation was detected will be referred to as the “scheduled charging location.” For example, after the vehicle 100A returns to the charging base, the ECU 150 performs charging at the charging base so that the amount of electricity stored in the vehicle 100A (more specifically, the battery 110) reaches a predetermined target value (value d). A recommended value e of the charging amount at the scheduled charging location is calculated.

Specifically, ECU 150 acquires the amount of power stored in vehicle 100A at the scheduled charging location (value a) and the amount of power consumed by vehicle 100A before arriving at the charging base (value b). The SOC value indicating the amount of electricity stored in the battery 110 of the vehicle 100A at the scheduled charging location corresponds to the value a. The amount of power required for the vehicle 100A to return to the house 10A from the scheduled charging location (the amount of power required to reach the charging base) corresponds to the value b. ECU 150 obtains value X (result of the subtraction) by subtracting value b from value a. ECU 150 may calculate the amount of power required to reach the charging base, taking into consideration the distance and elevation difference between the scheduled charging location and the charging base. The amount of power required to reach the charging station includes not only the amount of power consumed while driving, but also the amount of power consumed by on-vehicle equipment (for example, an air conditioner) while driving. The ECU 150 may estimate the amount of power consumed by the air conditioner while the vehicle is running based on the outside air temperature.

Subsequently, ECU 150 obtains value Y (result of addition) by adding the predicted charge amount (value c) on the VPP execution date to value X (result of subtraction). The value c corresponds to the amount of charge on the VPP execution date predicted the day before the VPP execution date using the method shown in FIG. 3. The ECU 150 subtracts the value Y from the value d to obtain the recommended charge amount e (result of the subtraction). The value d can be set arbitrarily, and may be available whether it is the amount of stored power equivalent to a full charge or the amount of stored power close to a full charge (for example, about 80% in SOC value), it is the amount of stored power that enables driving on the next day of the VPP execution date.

As described above, in this embodiment, ECU 150 calculates the recommended value e of the charging amount using a calculation formula such as “recommended value e=d+b−(a+c)”. According to such a method, it becomes easy to obtain the amount of charge that allows the electrified vehicle to arrive at the charging station and perform energy management as the recommended value e of the amount of charge. However, the method for calculating the recommended value e is not limited to the above.

In subsequent S14, the ECU 150 determines whether the recommended value e of the charging amount is greater than zero. When the value Y is lower than the value d, that is, when the recommended value e of the charging amount is larger than 0 (YES in S14), the recommended value e of the charging amount becomes a positive value. In this case, the ECU 150 determines a value obtained by subtracting the value Y from the value d (the difference between the value Y and the value d) as the recommended value e of the charging amount. Then, in subsequent S15, ECU 150 requests permission from the user of vehicle 100A to set the upper limit of charging amount at a location other than the charging base to the recommended charging amount e. Specifically, the ECU 150 controls the HMI 180 (touch panel display) so that the HMI 180 (touch panel display) displays the screen Sc1. Screen Sc1 includes a display unit M11 displaying a message informing the user that energy management is scheduled for today and an incentive for energy management, and a message requesting permission from the user to limit the charging amount to the recommended value e (kWh). Screen Sc1 further includes an operation unit M12 for permitting restriction of the amount of charge in response to a request, and an operation unit M13 for rejecting the request.

In subsequent S16, ECU 150 determines whether the above-mentioned permission has been received from the user of vehicle 100A. The user can reject the request from the ECU 150 by operating the operation unit M13. If the user rejects the request (NO in S16), the process flow of FIG. 5 ends. Further, the user can permit ECU 150 to limit the amount of charge by operating operation unit M12. If the ECU 150 receives permission from the user of the vehicle 100A (YES in S16), in the subsequent S17, the ECU 150 sets the upper limit of the charging amount at the scheduled charging location (a location other than the charging base) to the recommended value e calculated in S13. As a result, the amount of charge at the scheduled charging location is limited to the recommended value e. When the process of S17 is executed, the process flow of FIG. 5 ends. Note that the upper limit value of the charging amount set in S17 is valid only for charging at the scheduled charging location, and does not limit the charging amount at the charging base. Further, the upper limit value of the charging amount set in S17 is canceled when the VPP execution date has passed.

On the other hand, if the value Y is greater than or equal to the value d, the recommended value e of the charging amount becomes “0” or a negative value, and NO is determined in S14. A NO determination in S14 means that the value X is sufficiently large and the value a is larger than the value b. In this case, in subsequent S18, ECU 150 notifies the user of vehicle 100A that it is recommended not to charge at the scheduled charging location (a location other than the charging base). Specifically, the ECU 150 controls the HMI 180 so that the HMI 180 displays the screen Sc2. Screen Sc2 displays a message informing the user that energy management at home (house 10A) is scheduled for today and that the user will not run out of power even if he does not charge at the scheduled charging location, and a message informing the user not to charge outside of his home. Display a message prompting you. When the process of S18 is executed, the process flow of FIG. 5 ends.

A user of vehicle 100A can charge battery 110 by operating a charging operation unit of vehicle 100A or EVSE (electric power supply equipment) even at locations other than the charging base. That is, the user of vehicle 100A can charge battery 110 not only at home but also while going out. In this case, the ECU 150 controls the charging circuit 130 according to instructions from the user. However, when charging at a scheduled charging location (a place other than a charging base), if an upper limit value (recommended value e) for the amount of charge is set in the ECU 150, the ECU 150 will be able to detect if the amount of charge exceeds the upper limit value. The charging circuit 130 is controlled so as not to occur. When the amount of charge in battery 110 reaches the upper limit, charging of battery 110 ends.

As described above, the energy management method according to this embodiment includes the processes shown in FIGS. 3 to 5. Each process is executed by one or more processors executing programs stored in one or more memories. However, these processes may be executed by dedicated hardware (electronic circuitry) instead of software.

The energy management method according to this embodiment includes scheduling the charging of an electrified vehicle for energy management to be performed at a predetermined charging base on a predetermined date (see FIGS. 3 and 4), and If pre-charging operation of the electrified vehicle is detected at a location other than the charging base, the recommended charging amount for the electrified vehicle at that location is calculated (13 in FIG. 5), and the charging amount is calculated at the location other than the charging base. Ask the user of the electrified vehicle for permission to set the upper limit of the charging amount to the recommended value of the charging amount (S15 in FIG. 5), and if permission is received from the user of the electrified vehicle, This includes setting the upper limit value of the charging amount at the location to the recommended charging amount (S17 in FIG. 5). In such a method, by limiting the amount of charging at locations other than the charging base, charging for energy management purposes is more likely to be carried out at the charging base. Further, by requesting permission from the user of the electrified vehicle prior to limiting the amount of charge, it is possible to prevent user convenience from being excessively impaired. Further, since the user can perform charging up to the recommended charging amount, the user's convenience is prevented from being excessively impaired due to the limitation of the charging amount. Thus, both effectiveness of energy management and convenience of the user can be realized. In addition, by improving the efficiency of energy management by electrified vehicles, it will be easier to increase the volume of electricity trading and increase profits. By displaying incentives, users can be motivated to participate in energy management. Instead of incentives, the environmental effects of energy management (for example, the amount of carbon dioxide emission reduction) may be displayed.

The above energy management method involves predicting the charging preparation completion time and charging amount of the electrified vehicle for the next day at the charging station (see FIG. 3), and based on the charging preparation completion time and charging amount predicted on the previous day, charging the electrified vehicle (see FIG. 2). According to such a method, the charge preparation completion time and charge amount of the electrified vehicle are predicted the day before, and the electrified vehicle is charged based on the prediction result. Therefore, it becomes easier to make a schedule for energy management.

The notification to the vehicle user (S15, S18 in FIG. 5) may be performed by a user terminal (for example, a communication device having a user interface) outside the vehicle instead of the vehicle-mounted HMI (HMI 180). Examples of user terminals outside the vehicle include smartphones, portable game machines, wearable devices (for example, wristwatch-type communication devices), and electronic keys. The notification to the vehicle user may be made by voice instead of display.

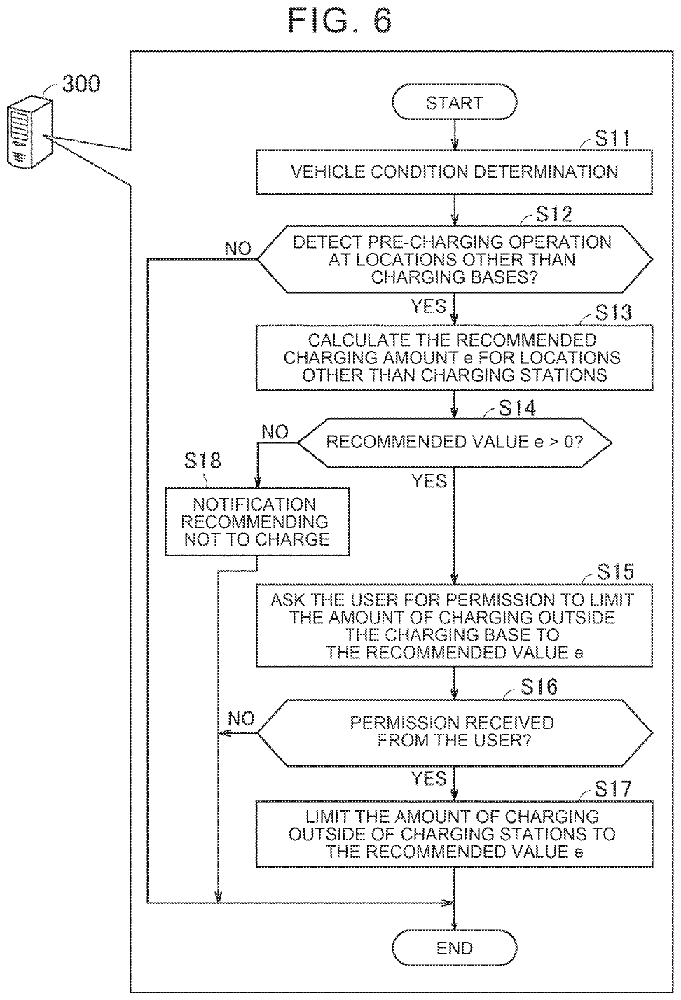

Server 300 may execute the series of processes shown in FIG. 5 instead of the vehicle. FIG. 6 is a diagram showing an example of the server 300 executing the series of processes shown in FIG. 5. Server 300 may request vehicle 100 to notify the vehicle user. Server 300 may receive an answer from the vehicle user from vehicle 100. The server 300 may request the second electrified vehicle to perform energy management on behalf of the first electrified vehicle when the first electrified vehicle rejects the request to limit the amount of charge (NO in S16).

The processing flow shown in FIG. 5 or 6 can be changed as appropriate. For example, the order of processing may be changed, or unnecessary steps may be omitted, depending on the purpose. Also, the content of any one of the processes may be changed. The start timing of the processing flow is not limited to the start of travel and the end of travel, and can be set arbitrarily. The processing flow may be executed only at either the start of travel or the end of travel.

In the above-described embodiment, a prediction program for predicting the future usage of vehicle 100 from past usage data of vehicle 100 is implemented in server 300 (on-premises server) (see FIG. 3). However, the present disclosure is not limited thereto, and instead of the server 300, such a prediction program may be implemented in the vehicle 100, the EVSE 200, or the Energy Management System (EMS) of the house 10A. Also, the functions of the server 300 may be implemented on the cloud.

The configuration of the electrified vehicle used for energy management is not limited to the configuration described above (see FIG. 2). An xEV other than a BEV may be employed, for example, a plug-in hybrid electric vehicle (PHEV) equipped with an internal combustion engine may be employed. The electrified vehicle may be configured for contactless charging. An electrified vehicle that performs contactless charging may be considered to be in a state corresponding to the “plug-in state” described above when alignment between the power transmission unit (e.g., power transmission coil) on the power supply equipment side and the power reception unit (e.g., power reception coil) on the vehicle side is completed. The electrified vehicle is not limited to a four-wheel passenger car, but may be a bus or truck, or a three-wheel xEV.

The embodiments disclosed herein should be considered to be exemplary and not restrictive in all respects. The scope of the present disclosure is shown by the scope of claims rather than the description of the above embodiment, and is intended to include all modifications within the meaning and the scope equivalent to the scope of claims.

What is claimed is:

1. An energy management method comprising:
scheduling charging of an electrified vehicle for energy management to be executed at a predetermined charging site on a predetermined execution date;
when pre-charging operation of the electrified vehicle is detected at a location other than the charging site on the execution date, calculating a recommended value of a charging amount at the location for the electrified vehicle;
requesting permission from a user of the electrified vehicle to set an upper limit value of a charging amount at a location other than the charging site to the recommended value; and
when the permission is received from the user of the electrified vehicle, setting the upper limit value of the charging amount at a location other than the charging site to the recommended value.

2. The energy management method according to claim 1, wherein the pre-charging operation includes at least one of stopping the electrified vehicle at a location where charging is executable, opening a charging lid of the electrified vehicle, and setting a destination of the electrified vehicle to a location where charging is executable.

3. The energy management method according to claim 1, further comprising:
predicting a charging preparation completion time and a charging amount of the electrified vehicle for a following day for the charging site; and
charging the electrified vehicle at the charging site based on the charging preparation completion time and the charging amount predicted on a preceding day.

4. The energy management method according to claim 3, wherein the calculating of the recommended value includes:
subtracting an amount of power that the electrified vehicle consumes before arriving at the charging site from an amount of power stored in the electrified vehicle at a location other than the charging site at which the pre-charging operation is detected;
adding the charging amount for the execution date predicted on a day before the execution date to a result of the subtracting; and
when a result of the adding is less than a predetermined amount of stored power, setting a difference between the result of the adding and the predetermined amount of stored power to the recommended value.

5. A computer system comprising:
one or more processors; and
one or more storage devices that store a program that causes the one or more processors to execute the energy management method according to claim 1.
